(19) United States
(12) Patent Application Publication
(10) Pub. No.: US 2018/0345914 A1
(43) Pub. Date: Dec. 6, 2018

(54) BEARING COMPRISING AN ARM FOR BLOCKING A WIPER LINKAGE IN A POSITION FOR TRANSPORT, LINKAGE SUB-ASSEMBLY AND RELATED LINKAGES, AND METHOD FOR BLOCKING A WIPER LINKAGE IN A POSITION FOR TRANSPORT

(71) Applicant: Valeo Systèmes d'Essuyage, Le Mesnil Saint Denis (FR)

(72) Inventors: Pascal Renoux, Issoire (FR); Nicolas Kuchly, Issoire (FR); Robin Viard, Issoire (FR)

(73) Assignee: Valeo Systèmes d'Essuyage, Le Mesnil Saint Denis (FR)

(21) Appl. No.: 16/000,632

(22) Filed: Jun. 5, 2018

(30) Foreign Application Priority Data
Jun. 5, 2017 (FR) 1754971

(51) Int. Cl. B60S 1/34

(52) U.S. Cl. CPC B60S 1/3493

(57) ABSTRACT

The present invention consists in a bearing (1) of a linkage of a wiper mechanism, characterized in that the bearing (1) includes an arm (11) for retaining a link in a transport position, the retaining arm (11) housing at its free end (11a) an element (13) for locking the link in a transport position; said locking element (13) being mobile in translation between an unlocked position and a locking position in which the link is locked in the transport position.

The present invention relates to the field of the linkages of wiper mechanisms, in particular for motor vehicles, and more particularly to locking these linkages in a transport position. The present invention relates more specifically to a retaining arm comprising an element for locking a linkage in a transport position. The present invention also relates to a linkage subassembly and to a linkage including this kind of retaining arm and also to a method of locking a linkage of this kind.

Motor vehicle wiper mechanism linkages are systems articulated at various locations. This articulation is necessary for the correct functioning of the wiper system once the linkage has been installed on the motor vehicle. However, this kind of articulation causes problems in particular for transporting this linkage and for installing it on the motor vehicle. Accordingly, it is necessary to limit the degrees of freedom of the linkage both during transport and during installation thereof.

There are known locking elements enabling connection of the link to bearings enabling fixing of the linkage to the motor vehicle so that the linkage is in a transport position. The known prior art locking elements can take various forms, such as a clamp form, for example, in order to lock this linkage in a transport and installation position, that is to say in a position in which all movement of a bearing of the linkage relative to the link is prevented.

However, the known locking elements are for single use and are removed by cutting, for example after installation of the linkage on the motor vehicle. Accordingly, it is necessary to use tools, generally cutting tools, in order to be able to release the linkage. Moreover, this kind of locking element produces debris that it will be necessary to process afterwards, which generates additional costs.

An objective of the present invention is to alleviate at least partly the disadvantages of the prior art described above.

Another objective of the present invention, different from the preceding objective, is to propose a locking element of a linkage of a wiper mechanism in particular for motor vehicles that can be removed without necessitating tools.

Another objective of the present invention, different from the preceding objectives, is to propose a locking element that can remain on the linkage of the wiper mechanism once the latter has been installed so as to reduce the production of waste to be processed.

Another objective of the present invention, different from the preceding objectives, is to propose a locking element that is simple to install on a linkage of a wiper mechanism.

A further objective of the present invention, different from the preceding objectives, is to propose a locking element that enables simple release of the linkage of the wiper mechanism.

To this end, in order to achieve at least one of the aforementioned objectives at least partly, the present invention consists in a bearing of a linkage of a wiper mechanism, the bearing including an arm for retaining a link in a transport position, the retaining arm housing at its free end an element for locking the link in a transport position, said locking element being mobile in translation between an unlocked position and a locking position in which the link is locked in the transport position.

The locking element locks the linkage in the transport position by locking the position of the link relative to the bearing. The use of the locking element to lock or to release the link in order to retain the linkage in the transport position advantageously does not necessitate any tool.

The bearing may further comprise one or more of the following features separately or in combination.

The mobile element moves in translation in a direction parallel to the retaining arm.

According to a variant, the locking element is housed at least partly in the retaining arm when it is in the unlocked position.

The locking element comprises at least one wall parallel to the direction of movement of the locking element and carrying a retaining lug, said retaining lug being intended to come into contact with a first face of the link opposite a second face disposed facing the bearing.

According to one embodiment, the locking element comprises parallel first and second wails disposed on respective opposite sides of the locking element and parallel to the direction of movement of the locking element, said parallel first and second walls being configured to sandwich the link between them when the locking element is in the locking position.

According to this embodiment, the first wall and the second wall each carry a retaining lug.

According to this embodiment, the first and second walls are spaced by a height greater than the thickness of the link and preferably equal to the thickness of the link.

The locking element includes a maneuvering peg disposed on a first face of the locking element.

The retaining arm is in one piece with the bearing.

According to a variant, the locking element includes at least two fingers disposed on respective opposite sides of a second face of the locking element opposite the first face, said at least two fingers serving as abutments for the locking element during its movement in translation along the retaining arm.

According to this variant, the free end of the retaining arm includes at least one cut-out shape serving as an abutment for the at least two fingers of the locking element when the latter is in the locking position.

The locking element is made of a plastic material or metal.

The present invention also consists in a subassembly of a linkage of a wiper mechanism, comprising:
a bearing as defined above,
a crank articulated on the bearing, said crank having a first end connected to the bearing and a second end carrying a ball joint, and
a link one end of which is connected by the ball joint to the crank,
   the retaining arm extending longitudinally in the direction of the link and being arranged in such a manner as to lock the link in the transport position.

The subassembly may further comprise one or more of the following features separately or in combination.

According to one embodiment, the link includes a U-section.

According to this embodiment the first wall has a length greater than that, of the second wall so that the retaining lug of the second wall is in contact with the interior of the surface of the second face of the U-section of the link and the retaining lug of the first wall is in contact with the exterior of the surface of the first face of the U-section of the link when the locking element is in the locking position.

The present invention also consists in a linkage of a wiper mechanism, characterized in chat it comprises first and second subassemblies connected to one another by a link, the first subassembly and/or the second subassembly is a subassembly as defined above, said first subassembly and/or second subassembly is adapted to be locked in the transport position with the aid of the locking element.

The first and second subassemblies are respectively disposed on a first side and a second side of the linkage.

The linkage further comprises a motor connected to at least one crank, said motor being configured to enable the movement in translation of the link.

The motor of the linkage is installed on the first side of the linkage.

The present invention also consists in a method of locking a link of a subassembly as defined above, the method comprising at least one of the following steps:
rotation of the link about the ball joint in order to position it in the transport position, and
movement of the locking element from the unlocked position to the locking position in order to hold one end of the link fixed relative to the bearing when the linkage is in the transport position.

The subassembly includes a bearing as defined above and the locking element is moved by pushing the locking element in the direction of the link with the aid of the maneuvering peg.

The link is advantageously released by pushing the maneuvering peg in the direction away from the link.

The blocking element may remain on the retaining arm after the link is released.

The retaining arm may remain on the bearing after installation of the linkage.

According to one embodiment, the linkage includes two bearings disposed on respective opposite sides of a link, each bearing comprising a retaining arm as defined above, said retaining arms being configured to lock the first and second sides of the linkage in the transport position.

The locking in the transport position of the link from the first or second side of the linkage with the aid of the locking element is reversible.

Other features and advantages of the present invention will become more clearly apparent on reading the following description given by way of nonlimiting illustrative example and from the appended drawings, in which:

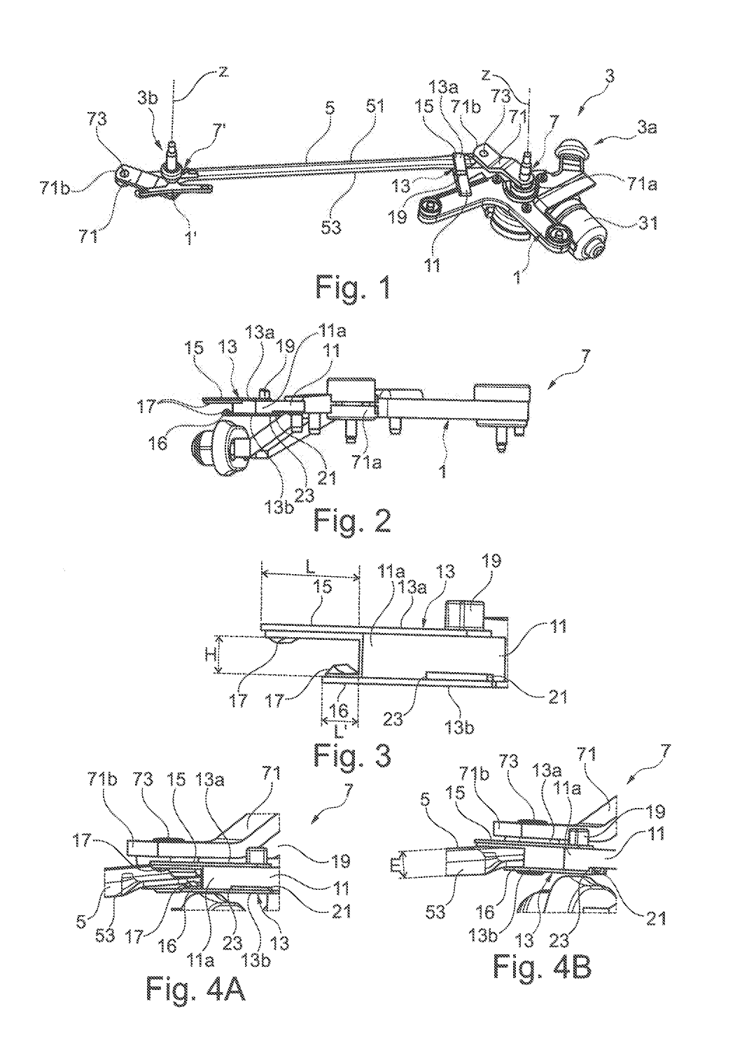

FIG. 1 is a diagrammatic perspective view of a linkage locked in a transport position,

FIG. 2 is a diagrammatic perspective view of a linkage subassembly including a retaining arm according to one particular embodiment,

FIG. 3 is a diagrammatic perspective view of the retaining arm from FIG. 2 including a locking element in an unlocked position,

FIG. 4A is a diagrammatic perspective view of a linkage subassembly during a step of positioning a link in a transport position, and

FIG. 4B is a diagrammatic perspective view of the linkage subassembly from FIG. 4A when the link is locked in the transport position.

In these figures, identical elements bear the same reference numbers.

The following embodiments are examples. Although the description refers to one or more embodiments, this does not necessarily mean that each reference concerns the same embodiment or that the features apply only to only one embodiment. Single features of different embodiments may equally be combined or interchanged to produce other embodiments.

The following description refers to first and second sides of the linkage, to first and second ends of the crank, to first and second faces of the link, to first and second faces of the locking element, to first and second walls of the locking element, and to first and second subassemblies of the linkage. This is merely indexing to differentiate and to designate elements that are close but not identical. This indexing does not imply any priority of one element over another and such designations may easily be interchanged without departing from the context of the present description. Nor does this indexing imply an order in time, for example to assess the disposition of the linkage on the motor vehicle, its operation, or again its installation, or again to appreciate the shape of the locking element or its use to retain the linkage in its transport position.

In the following description, there is meant in particular by “transport position” a position in which at least one end of the link and a crank to which that end of the link is connected form a minimum angle. To be more precise, at least this end of the link is in a position close to the bearing on which the crank is articulated so that the linkage has a minimum overall size when it is in the transport position.

Referring to FIGS. 1 to 3, there is represented a linkage 3 of a wiper mechanism of a motor vehicle reversibly locked in a transport position. The linkage 3 comprises a first subassembly 7′ disposed on a first side 3b of the linkage 3, a second subassembly 7 disposed on a second side 3a of the linkage 3, and a motor 31 configured to enable movement in translation of a link 5 connecting the first subassembly 7′ and the second subassembly 7 to one another and driven with an alternating pivoting movement of the axes Z intended to carry the wiper arm (not shown).

The first subassembly 7′ and the second subassembly 7 comprise a bearing 1 and a crank 71 articulated on the bearing 1. The crank 71 has a first end 71a connected to the bearing 1, for example by a pivot connection, and a second end 71b carrying a ball joint 73 on which the link 5 is articulated.

The bearing 1 comprises a retaining arm 11 extending longitudinally in the plans of the bearing 1 in the direction of the link 5.

Referring to FIG. 2, the retaining arm 11 includes at a free end 11a a locking element 13 mobile in translation between an unlocked position (here a retracted position) and a locking position (here a deployed position) in such a manner as to lock the link 5 in the transport position with the aid of at least one wall 15. To be more precise, the locking element 13 is mobile in translation in the plane of the bearing 1. Referring to FIG. 1, the retaining arm 11 holds the position of at least one end of the link 5 fixed relative to the bearing 1.

Referring to FIGS. 2 and 3, the mobile element 13 moves in translation between the unlocked position (FIG. 3) and the locking position (FIG. 2) in a direction parallel to the retaining arm 11. According to the particular embodiment from FIGS. 2 and 3, the unlocked position corresponds to a retracted position of the locking element 13 and the locking position corresponds to a deployed position of the locking element 13.

The locking element 13 comprises at least one wall 15 extending parallel to the direction of movement, of the locking element 13. The wall 15 is disposed on a first face 13a or the locking element 13. Also, the wall 15 carries a retaining lug 17 intended to come into contact with the first face 51 of the link 5 when the locking element 13 is in the looking position. The locking element 13 also has a maneuvering peg 19 disposed on the first face 13a of the locking element 13. According to this particular embodiment, the looking element 13 is made of a plastic material. According to another embodiment not shown here, the looking element 13 may be made of metal.

According to the particular embodiment from FIGS. 2 and 3, the locking element 13 comprises a first wall 15 and a second wall 16 that are parallel. The first wall 15 and the second wall 16 are disposed on respective opposite sides of the locking element 13 and extend parallel to the direction of movement of the locking element 13. To be more precise the first wall 15 is disposed on the first face 13a of the locking element 13 and the second wall 16 is disposed on a second wall 13b of the locking element 13 opposite the first wall 13a. The first wall 15 and the second wall 16 are configured to sandwich the link 5 between them when the locking element 13 is in the locking position. According to this particular embodiment, the first wall 15 and the second wall 16 each carry a retaining lug 17.

Referring to FIG. 3, the locking element 13 is housed at least partly in the retaining arm 11 when it is in the unlocked position.

Also, referring to FIG. 2, the retaining arm 11 is in one piece with the bearing 1. The retaining arm 11 is constituted of two walls constituting a rail intended to guide the locking element 13 during its movement between the unlocked position and the locking position in order to enable reversible locking of the first subassembly 7′ and/or the second subassembly 7 in the transport position. Also, referring to FIGS. 2 and 3, the free end 11a of the retaining arm 11 includes at least one cut-out shape 23 and the second face 13b of the locking element 13 includes at least two fingers 21 disposed facing the first face 13a. According to this particular embodiment, the fingers 21 are disposed facing the maneuvering peg 19. The cut-out shapes 23 are configured to serve as abutments for the at least two fingers 21 of the locking element 13 when the latter is in the locking position.

Referring to FIG. 3, the first wall 15 has a length L and the second wall 16 has a length L′. To be more precise, the first wall 15 has a length L greater than the length L′ of the second wall 16. According to the particular embodiment shown here, the link 5 corresponds to a U-section and the retaining lug 17 of the second wall 16 is configured to come into contact with the interior surface of the second face 53 of the U-section of the link 5 and the retaining lug 17 of the first wall 15 is configured to come into contact with the exterior surface of the first face 51 of the U-section of the link 5 (seen better in FIGS. 4A and 4B) when the locking element 13 is in the locking position. This kind of disposition of the first wall 15 and the second wall 16 makes it possible to block movement of the link 5 in two directions when the latter is the transport position.

Referring to FIG. 3, the first wall 15 and the second wall 16 are separated by a height H greater than the thickness E (visible in FIG. 4B) of the link 5 so as to be able to sandwich it between them. The height H is even more preferably equal to the thickness E of the link 5 so that the cooperation of the lugs 17 carried by the first wall 15 and the second wall 16 with the walls of the link 5 is reinforced.

According to the particular embodiment from FIG. 1, the motor 31 is connected to at least one crank 71. The motor 31 is disposed on the second side 3a of the linkage 3. The second side 3a generally corresponds to the driver side of the motor vehicle when the linkage 3 is installed on the latter. According to a variant, the second side 3a may correspond to the passenger side of the motor vehicle when the linkage 3 is installed on the latter. According to this particular embodiment, only the second side 3a of the linkage 3 includes a retaining arm 11. Accordingly, only the articulation of the end of the link 5 connected to the ball joint 73 carried by the second linkage subassembly 7 is locked when the linkage 3 is in the transport position.

According to another embodiment not shown here, the first subassembly 7′ and the second subassembly 7 can include on their respective bearing 1 a retaining arm 11. According to this other embodiment, the position of each end of the link 5 disposed on the first side 3b and the second side 3a of the linkage 3 is fixed relative to the first end 71a of the crank 71 carrying the ball joint connection 73 on which the end of the link 5 is articulated in order to retain the first side 3b and the second side 3a of the linkage 3 in the transport position. Accordingly, the articulation of each end of the link 5 is locked.

According to a further embodiment not shown here, only the first subassembly 7′ includes the retaining arm 11 in order to retain the first side 3b of the linkage 3 in the transport position. Accordingly, only the articulation of the end of the link 5 connected to the bail joint 73 carried by the first linkage subassembly 7′ is locked.

Locking the articulation of at least one end of the link 5 on the ball joint 73 carried by the first linkage subassembly 7′ or the second linkage subassembly 7 advantageously makes it possible to facilitate transporting this linkage 3 by eliminating degrees of freedom of movement of some parts of the linkage 3 and locking this linkage 3 in a position having a minimum overall size. Also, locking this articulation also makes it possible to facilitate the installation of this linkage 3 on the motor vehicle.

Referring to FIGS. 4A and 4B, there is shown a method of locking the link 5 of a subassembly 7 in the transport position.

Referring to FIG. 4A, the method includes a step a of rotation of the link 5 about the ball joint 73 in order to position the latter in the transport position. During this step a the locking element 13 is in the unlocked position.

Referring to FIG. 4B, the method also comprises a step b of movement of the locking element 13 from the unlocked position to the locking position. The change of position of the locking element 13 is for example effected by pushing the looking element 13 In the direction of the link 5 with the aid of the maneuvering peg 19. The passage of the locking element 13 to the locking position makes it possible to maintain an end of the link 5 fixed relative to the bearing 1 when the linkage 3 is in the transport position as shown in FIG. 4B. According to this particular embodiment, the link 5 corresponds to a U-section and the locking element 13 corresponds to that described with reference to the particular embodiment from FIG. 3. Accordingly, the retaining lug 17 of the second wall 16 cooperates with the interior of the U-section and the retaining lug 17 of the first wall 15 cooperates with the first face 51 of the link 5 when the locking element 13 is in the locking position.

Accordingly, the link 5 is locked in the transport position by the locking element 13 sliding along the retaining arm 11. This sliding does not necessitate the use of any tools.

Referring to FIG. 4B, the link 5 is released by pushing the maneuvering peg 19 in the direction away from the link 5 in order to return the locking element 13 to the unlocked position. During this movement, the retaining lugs 17 of the first wall 15 and the second wall 16 are moved toward the bearing 1 and release the link 5. Accordingly, the link 5 is released without necessitating the use of tools.

After the link 5 is released, the locking element 13 may remain on the retaining arm 11. Moreover, the retaining arm 11 may remain on the bearing 1 after installation of the linkage 3. The presence of the retaining arm 11 on the linkage 3 once the latter has been installed on the motor vehicle does not impede the operation of the wiper mechanism because the link 5 does not pass through the transport position during its movement in translation. Also, the possibility of leaving the retaining arm 11 and the locking element 13 on the bearing 1 offers the possibility of reusing them in the event of subsequent demounting of the linkage 3 for example. Moreover, this possibility of leaving these elements on the linkage 3 also makes it possible to limit the quantity of waste to be processed following the installation of this linkage 3.

The particular embodiments described above are examples given by way of nonlimiting illustration only. In fact, it is entirely possible for the person skilled in the art to reverse the arrangement of the first wall 15 and the second wall 16 without departing from the context of the present description. Moreover, the person skilled in the art could choose to use only one retailing lug 17 disposed in contact with the first wall 51 of the link 5 without departing from the context of the present description. Moreover, the person skilled in the art could utilize a locking element 13 housed on the exterior part of the retaining arm 11 without departing from the scope of the present invention.

Accordingly, the reversible retention of a linkage 3 of a wiper mechanism in a transport position is possible thanks to the retaining arm 11 including a locking element 13 as described above. The locking element 13 advantageously makes it possible to lock and to release the linkage 3 without necessitating the use of tools. Moreover, the use of this kind of retaining arm 11 makes it possible to limit the quantity of waste to be processed because it may remain on the bearing 1 following installation of the linkage 3 on the motor vehicle.

1. A bearing of a linkage of a wiper mechanism, the bearing comprising:
an arm for retaining a link in a transport position, the retaining arm housing at its free end an element for locking the link in a transport position,
said locking element being mobile in translation between an unlocked position and a locking position in which the link is locked in the transport position.

2. The bearing according to claim 1, wherein the locking element comprises at least one wall extending parallel to the direction of movement of the locking element and carrying a retaining lug, said retaining lug being intended to come into contact with a first face of the link opposite a second face disposed facing the bearing.

3. The bearing according to claim 1, wherein the locking element comprises a first wall and a second wall that are parallel, disposed on respective opposite sides of the locking element and extending parallel to the direction of movement of the locking element, said parallel first wall and second wall being configured to sandwich the link between them when the locking element is in the locking position.

4. The bearing according to claim 3, wherein, the first wall and the second wall each carry a retaining lug.

5. The bearing according to claim 1, wherein the locking element includes a maneuvering peg disposed on a first face of the locking element.

6. The bearing according to claim 1, wherein the locking element includes at least two fingers disposed on respective opposite sides of a second face of the locking element opposite the first face, said at least two fingers serving as abutments for the locking element during its movement in translation along the retaining arm.

7. The bearing according to claim 6, wherein the free end of the retaining arm includes at least one cut-out shape serving as an abutment for the at least two fingers of the locking element when the latter is in the locking position.

8. A subassembly of a linkage of a wiper mechanism, comprising:
a bearing according to claim 1;
a crank articulated on the bearing, said crank having a first end connected to the bearing and a second end carrying a ball joint; and
a link one end of which is connected by the ball joint to the crank,
the retaining arm extending longitudinally in the direction of the link and being arranged in such a manner as to lock the link in the transport position.

9. The subassembly according to claim 8, wherein the link includes a U-section.

10. The subassembly according to claim 9, wherein the first wall has a length greater than that of the second wall so that the retaining lug of the second wall is in contact with the interior of the surface of the second face of the U-section of the link and the retaining lug of the first wall is in contact with the exterior of the surface of the first face of the U-section of the link when the locking element is in the locking position.

11. A linkage of a wiper mechanism, comprising: a first subassembly; and a second subassembly connected to one another by a link, wherein the first subassembly and/or the second subassembly is a subassembly according to claim 8, wherein said first subassembly and/or second subassembly is adapted to be locked in the transport position with the aid of the locking element.

12. A method of locking a link of a subassembly according to claim 8 comprising at least one of the following steps:
(a) rotation of the link about the ball joint to position it in the transport position; and
(b) movement of the locking element from the unlocked position to the locking position in order to hold one end of the link fixed relative to the bearing when the linkage is in the transport position.

13. The method according to claim 12 of locking a link, the subassembly including the bearing in which the locking element includes a maneuvering peg disposed on a first face of the locking element, the locking element being moved by pushing the locking element in the direction of the link with the aid of the maneuvering peg.
